(19) United States
(12) Patent Application Publication
(10) Pub. No.: US 2014/0306477 A1
(43) Pub. Date: Oct. 16, 2014

(54) STORAGE BOX FOR A MOTOR VEHICLE

(71) Applicant: Ford Global Technologies, LLC, Dearborn, MI (US)

(72) Inventors: James Neugebauer, Chelmsford (GB); Andrew John Murray, Colchester (GB); Ed Stubbs, London (GB); Torsten Gerhardt, London (GB); Will Farrelly, Chelmsford (GB)

(73) Assignee: Ford Global Technologies, LLC, Dearborn, MI (US)

(21) Appl. No.: 14/246,688

(22) Filed: Apr. 7, 2014

(30) Foreign Application Priority Data
Apr. 10, 2013 (GB) 1306503.2

(51) Int. Cl. B60R 7/04

(52) U.S. Cl. CPC B60R 7/04
USPC 296/24.34

(57) ABSTRACT

A center console for a motor vehicle is disclosed in which the center console includes a front portion and a rear storage box portion defined by a pair of side walls, a rear wall, a floor, an armrest and a front wall. The front wall of the storage box is moveable between substantially upright and substantially horizontal positions so as to define two distinct storage configurations. When the front wall is in the upright position a single large closed storage box is defined by the pair of side walls, the rear wall, the floor, the armrest and the front wall. When the front wall is in the horizontal position a first large open storage area is defined by the pair of side walls, the rear wall, the armrest and the front wall. A reconfigurable storage facility is thereby provided in a cost effective and simple manner.

### FIELD OF THE INVENTION

The present invention generally relates to motor vehicles, and more particularly to a storage box for a motor vehicle.

### BACKGROUND OF THE INVENTION

It is known from, for example, CN-202413635 to provide a storage box forming part of a center console that provides a closed compartment in which articles can be stored out of view. Access to the closed compartment is facilitated by means of a pivotable lid in the form of an armrest for a user of the motor vehicle.

With such a conventional arrangement, large articles such as, for example, a ladies handbag or a small shopping bag often cannot be accommodated within the confines of the closed compartment. Further, with such an arrangement, if an article is to be stored or retrieved from such a closed compartment, the armrest has to be lifted to gain access and so is temporarily unavailable for use.

It would be desirable to provide a storage box for a motor vehicle that overcomes the problems or drawbacks associated with the above referred to conventional storage box in a cost effective and simple manner.

### SUMMARY OF THE INVENTION

According to a first aspect of the invention, there is provided a storage box for a motor vehicle, the storage box having two side walls, a front wall, a rear wall, a floor and a moveable lid wherein the front wall is moveable between a first substantially upright position in which it defines in combination with the other walls, the floor and the lid a large closed storage area and a second substantially horizontal position in which a large open storage area is formed.

According to further aspects of the invention, when in the second position, the front wall may define in combination with the other walls and the lid the large open storage area. Advantageously, when the front wall is in the second position, a second small closed storage area may be defined by the four walls and the floor between the front wall and the floor. Preferably, the front wall may be pivotally connected at a lower end so as to permit it to rotate between the first and second positions. The lid may be an armrest for a user of the motor vehicle. The storage box may be formed as part of a center console and the center console may further comprise an elongate front portion extending forwardly from the storage box.

According to another aspect of the present invention, a motor vehicle storage box is provided. The storage box includes two side walls, a rear wall, a floor, a moveable lid, and a front wall moveable between a first substantially upright position to define a closed storage area formed by the front wall, the two side walls, the rear wall, the floor and the lid, and a second substantially horizontal position to form an open storage area.

According to a further aspect of the invention, there is provided a motor vehicle having a storage box. The storage box includes two side walls, a rear wall, a floor, a moveable lid, and a front wall moveable between a first substantially upright position to define a closed storage area formed by the front wall, the two side walls, the rear wall, the floor and the lid, and a second substantially horizontal position to form an open storage area.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a pictorial representation of a center console including a storage box constructed in accordance with a first aspect of the invention;

FIG. 2 is a view in the direction of arrow ‘A’ on FIG. 1 showing a rear wall of the storage box;

FIG. 3 is a cross section along a longitudinal center line of the center console showing a front wall of the storage box in a first upright position;

FIG. 4 is a cross section along the longitudinal center line of the center console showing the front wall in a second horizontal position; and

FIG. 5 is a schematic plan view of a motor vehicle according to a second aspect of the invention showing the location of the center console within a passenger compartment of the motor vehicle.

### DETAILED DESCRIPTION OF THE PREFERRED EMBODIMENTS

While various aspects of the inventive subject matter are described with reference to a particular illustrative embodiment, the inventive subject matter is not limited to such embodiments, and additional modifications, applications, and embodiments may be implemented without departing from the inventive subject matter. In the figures, like reference numbers will be used to illustrate the same components. Those skilled in the art will recognize that the various components set forth herein may be altered without varying from the scope of the inventive subject matter.

It will be appreciated that the figures are exemplary in nature, are not drawn to scale, and do not represent styled components for use on an actual motor vehicle.

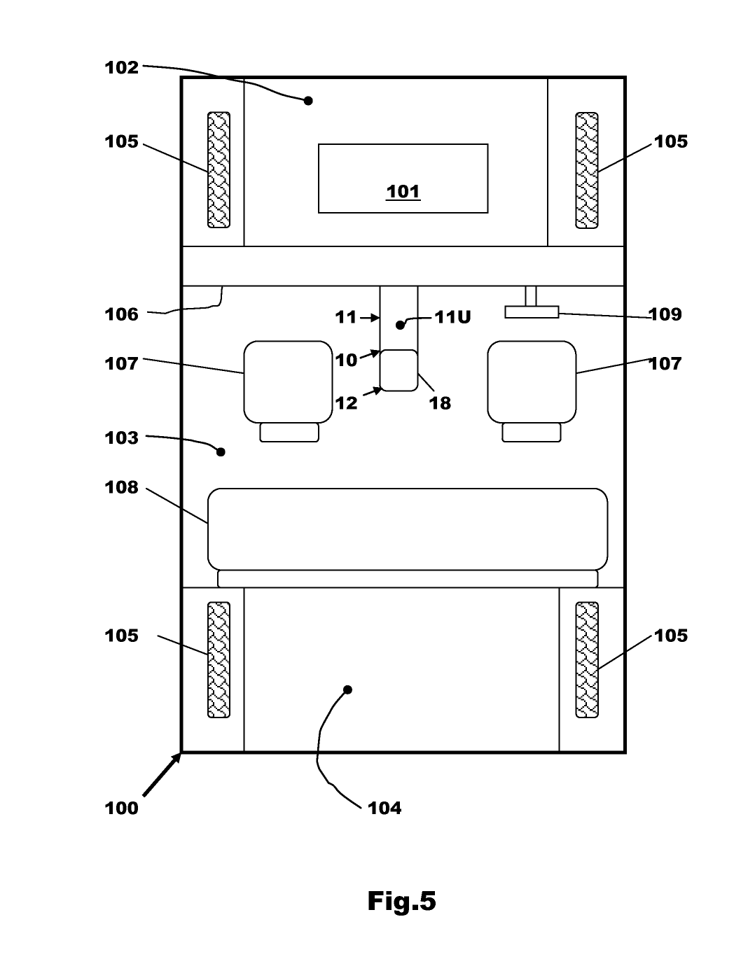

With particular reference to FIG. 5, there is shown a motor vehicle 100 having four road wheels 105, an engine 101 located in an engine compartment 102 of the motor vehicle 101, front and rear seats 107, 108 mounted in a passenger compartment 103 of the motor vehicle 101 and a luggage compartment 104. The motor vehicle 100 further comprises an instrument panel or dashboard 106 extending across the passenger compartment 103 at a front end thereof, a steering wheel 109 and a center console 10 located at least partially between the front seats 107.

The center console 10 includes an elongate front portion 11 having an upper panel 110 and a storage box portion 12 including an armrest 18. In the example shown, a front end of the elongate front portion 11 connects to or co-operates with a lower part of the instrument panel 106 but this need not be the case and the front portion 11 may terminate before it reaches the instrument panel 106. In addition, the storage box 12 and the front portion 11 may be separate components rather than a single component and in some embodiments there may be no front portion 11, only a storage box 12 fitted to the motor vehicle 100.

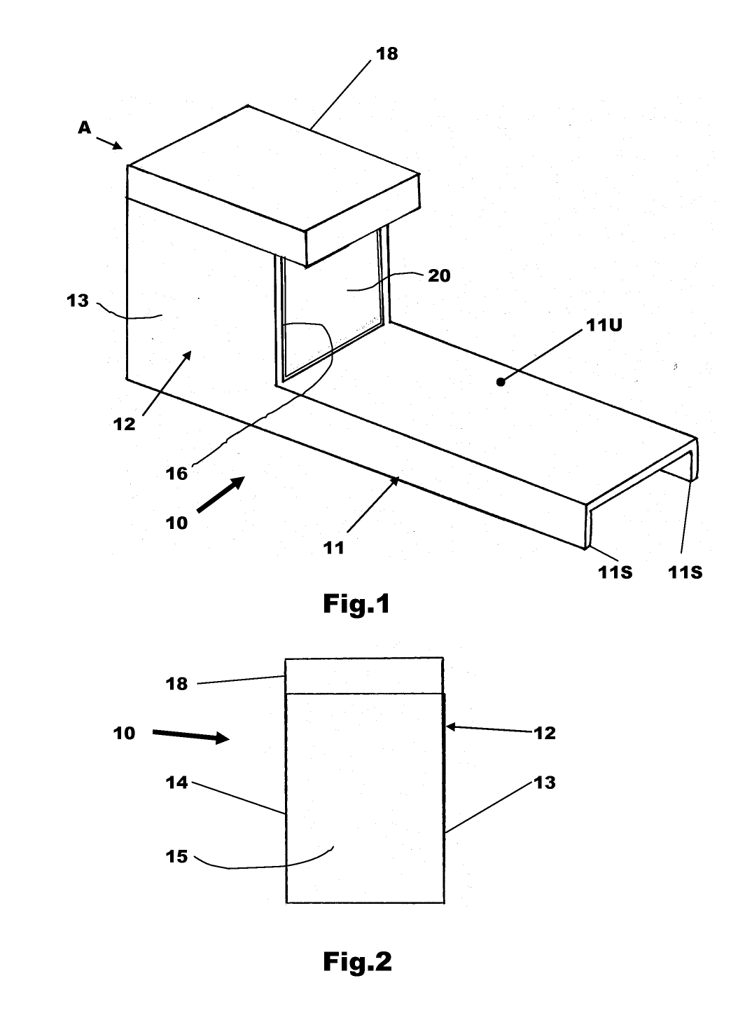

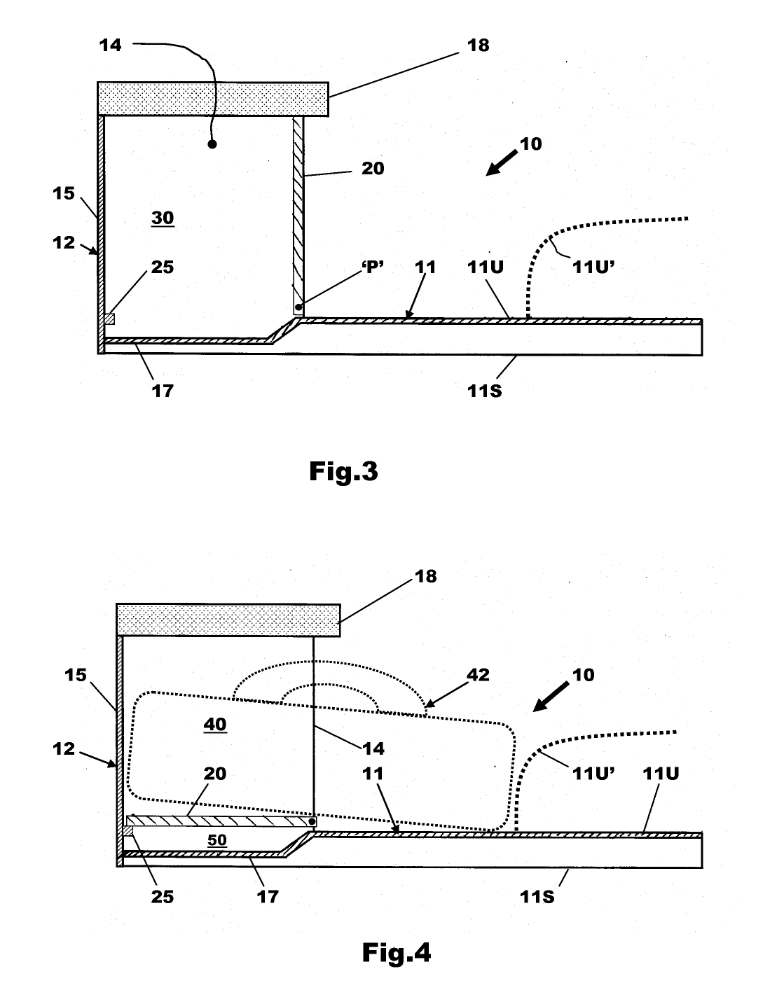

With reference to FIGS. 1-4 the center console 10 will now be described in more detail. The center console 10 includes the storage box portion 12 and the front portion 11. The front portion 11 has an upper panel 11U and two depending sides walls 11S. In practice the upper panel 11U may include an aperture for the passage of a gear change lever and/or handbrake lever and several other apertures to accommodate switches and may be ‘kicked up’ at the front end as indicated by the dotted line 11U′ on FIGS. 3 and 4.

The storage box 12 is defined by two side walls 13, 14, a rear wall 15, a front wall 20, a floor 17 and a lid in the form of an armrest 18. The armrest 18 is hingedly connected to an upper end of the rear wall 15 by hinge means (not shown). It will be appreciated that the armrest 18 could alternatively be hingedly connected to one of the side walls 13, 14 by hinge means or could slide to provide access to the interior of the storage box 12.

The rear wall 15 and the side walls 13, 14 are all substantially vertically arranged so as to form ‘upright’ walls and the front wall 20 is moveable between a first position (as shown in FIGS. 1 and 3) where it is upright to a second or ‘stowed’ position (as shown in FIG. 4) where it is substantially horizontally disposed.

In the embodiment shown, the two side walls 13, 14 of the storage box 12 are formed integrally with the side walls 11S of the front portion 11 but this need not be the case. The two side walls 13, 14 of the storage box 12 along with the upper panel 11U of the front portion 11 and a lower surface of the armrest 18 define an opening or access aperture 16 that is closed-off or opened by the front wall 20 depending upon whether the front wall 20 is in the first position or the second position, respectively.

The front wall 20 is pivotally connected at a lower end to either the two side walls 13, 14 or the upper panel 11U of the front portion 11 by hinge means (not shown). A latching means (not shown) is provided to retain the front wall 20 in the first position. When the latching means is released by a user of the motor vehicle 100, the front wall 20 can be moved from the first position to the second position.

A support 25 which may be in the form of a secondary latch is provided in this case on an inner face of the rear wall 15 to support a free end of the front wall 20 when the front wall 20 is moved to the second position. It will be appreciated that the support 25 could be replaced by other means to support the free end of the front wall 20 when it is in the second position.

A handle or pull cord could be provided on the front wall 20 to assist in moving it between the second and first positions. Alternatively, a mechanism could be provided biasing the front wall 20 into the first position so that it will automatically return to the first position if it is not latched in the second position. A remote user operable release button or lever could be provided to release the latch used to hold the front wall in the second position. The latch could be electrically or manually operable.

Referring now specifically to FIG. 3 the front wall 20 is shown in its first or ‘upright’ position. When the front wall 20 is in this position it defines in combination with the two side walls 13, 14, the rear wall 15, the floor 17 and the armrest 18 a large closed storage area 30. Articles can be stored in the large storage area 30 and access to the large storage area 30 can be obtained by lifting the armrest 18 so that it pivots upwardly.

It will be appreciated that locks could be provided to lock the front wall 20 in the first position and the armrest 18 in the down or closed position so as to produce a secure large closed storage area.

Referring now specifically to FIG. 4 the front wall 20 is shown in its second or ‘stowed’ position. When the front wall 20 is in this position it defines in combination with the two side walls 13, 14, the rear wall 15 and the armrest 18 a large open storage area 40.

Articles can be stored in the large open storage area 40 and access to the large open storage area 40 can be obtained via the access aperture 16 (shown on FIG. 1) or by lifting the armrest 18 so that it pivots upwardly. A large article in the form of a ladies handbag 42 is shown in dotted outline on FIG. 4. It will be appreciated that the ladies handbag 42 is too long to be stored in the large closed storage area 30 but can be accommodated in the large open storage area 40 because it can extend out through the access aperture 16 so as to lie partially on the upper panel 11U of the front portion 11 of the center console 10. It should be appreciated that the handbag 42 can be placed in the large open storage area 40 without needing to move the armrest 18 and that the armrest 18 therefore remains useable during this period of time. Therefore, articles can be placed in or retrieved from the large open storage area 40 without affecting use of the armrest 18 by a user of the motor vehicle 100.

In the case of the embodiment shown, a second small closed storage area 50 is defined by the four walls 13, 14, 15, 20 and the floor 17 between the front wall 20 and the floor 17 when the front wall 20 is in the second or ‘stowed’ position. In other embodiments a second small stowage area may not be provided if, for example, the front wall 20 folds down onto the floor 17 when in the second position. The second closed storage area 50 is useful for stowing small items such as, for example and without limitation, a mobile phone, sunglasses or keys.

One advantage of the small closed storage area 50 is that any articles stored in the small closed storage area 50 are not visible if left in the motor vehicle 100 while it is parked while the front wall 20 is in the second position. A further advantage is that articles stored in the small closed storage area 50 will not be accidently removed when an article is removed from the large open storage area 40.

It will be appreciated that a lock could be provided to lock the front wall 20 in the second position so as to produce a small secure storage area.

Although the invention has been described with reference to an embodiment in which the front wall is pivotally connected at a lower end thereby allowing it to rotate between the first and second positions it will be appreciated that the front wall could be removable from the storage box and securing means could be provided to permit the front wall to be secured to the storage box in the first position or in the first and second positions. For example, opposing pairs of vertical grooves could be provided in the two side walls with which the front wall is slidingly engageable. In such a case, the front wall is engageable with the opposed pair of vertical grooves to position it in the first position and is removed from the vertical grooves and stored elsewhere to form the large open storage area.

Alternatively, opposing pairs of vertical and horizontal grooves could be provided in the two side walls with which the front wall is slidingly engageable. In such a case, the front wall is engageable with the opposed pair of vertical grooves to position it in the first position and is engageable with the opposed pair of horizontal grooves to position it in the second position.

As previously referred to, latching means or locking means could be provided to hold or lock the front wall in position.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

What is claimed is:

1. A storage box for a motor vehicle, the storage box comprising two side walls, a front wall, a rear wall, a floor and a moveable lid, wherein the front wall is moveable between a first substantially upright position in which it defines in combination with the two side walls, the rear wall, the floor and the lid a closed storage area and a second substantially horizontal position in which an open storage area is formed.

2. The storage box as claimed in claim 1, wherein when in the second position, the front wall defines in combination with the two side walls, the rear wall and the lid the open storage area.

3. The storage box as claimed in claim 2, wherein when the front wall is in the second position, a second smaller closed storage area is defined by the front wall, rear wall, two side walls and the floor between the front wall and the floor.

4. The storage box as claimed in claim 2, wherein the front wall is pivotally connected at a lower end so as to permit the front wall to rotate between the first and second positions.

5. The storage box as claimed in claim 1, wherein the lid is an armrest for a user of the motor vehicle.

6. The storage box as claimed in claim 1, wherein the storage box is formed as part of a center console and the center console further comprises an elongate front portion extending forwardly from the storage box.

7. A motor vehicle having a storage box as claimed in claim 1.

8. A motor vehicle storage box comprising:
two side walls;
a rear wall;
a floor;
a moveable lid; and
a front wall moveable between a first substantially upright position to define a closed storage area formed by the front wall, the two side walls, the rear wall, the floor and the lid, and a second substantially horizontal position to form an open storage area.

9. The storage box as claimed in claim 8, wherein when in the second position, the front wall defines in combination with the two side walls, the rear wall and the lid the open storage area.

10. The storage box as claimed in claim 9, wherein when the front wall is in the second position, a second smaller closed storage area is defined by the front wall, the two side walls, the rear wall and the floor between the front wall and the floor.

11. The storage box as claimed in claim 9, wherein the front wall is pivotally connected at a lower end so as to permit it to rotate between the first and second positions.

12. The storage box as claimed in claim 8, wherein the lid is an armrest for a user of the motor vehicle.

13. The storage box as claimed in claim 8, wherein the storage box is formed as part of a center console and the center console further comprises an elongate front portion extending forwardly from the storage box.

14. A motor vehicle having a storage box comprising:
two side walls;
a rear wall;
a floor;
a moveable lid; and
a front wall moveable between a first substantially upright position to define a closed storage area formed by the front wall, the two side walls, the rear wall, the floor and the lid, and a second substantially horizontal position to form an open storage area.
